(19) United States
(12) Patent Application Publication
(10) Pub. No.: US 2011/0163530 A1
(43) Pub. Date: Jul. 7, 2011

(54) TAPERED TYPE CONNECTOR FOR A FLEXIBLE TUBE

(75) Inventor: SHIN-HSUNG SHIH, TAIPEI COUNTY (TW)

(73) Assignee: RAINBOW-TRUST INDUSTRIAL CO., LTD., TAIPEI COUNTY (TW)

(21) Appl. No.: 12/652,179

(22) Filed: Jan. 5, 2010

(51) Int. Cl. F16L 35/00

(52) U.S. Cl. 285/24

(57) ABSTRACT

A tapered type connector for a flexible tube, comprising: a) a coupling body having an external threaded portion and a stranded portion at one side thereof, an annular cavity being formed in the external threaded portion such that the stranded portion is extended into the annular cavity, the defining wall of the annular cavity being tapered inward to form a first external fastening cone, the end portion of the flexible tube fitting over the stranded portion; b) a clamp ring having at the internal end thereof a fist internal fastening cone facing to the first external fastening cone of the coupling body and at the external end thereof a second internal fastening cone, a clamp indentation being formed axially in the clamp ring, the clamp ring slipping over the periphery of the outer end of the flexible tube; and c) a clamp nut having an internal threaded portion (corresponding to the external threaded portion of the coupling body) and a second external fastening cone (corresponding to the second internal fastening cone of the clamp ring). The clamp nut includes an opening at the external end thereof. In this way, the connection strength tends to be enhanced to solve the problem of poor connection strength of the conventional connector.

### BACKGROUND OF THE INVENTION

1. Field of the Invention

The invention relates to a tapered type connector for a flexible tube, and more particularly to a connector having a clamp ring with two fastening cones and an axial clamp indentation. Meanwhile, the coupling body and the clamp nut are provided with a corresponding fastening cone, respectively.

2. Description of the Related Art

As shown in FIGS. 1 through 3, a conventional connector secured to the end of a flexible tube 10 includes a coupling body 21 with an external threaded portion 211 and a stranded portion 212 at one side thereof. The flexible tube 10 fits over the stranded portion 212 of the coupling body 21. A tapered bush 22 is mounted over the periphery of the end portion of the flexible tube 10. An inner cone 221 is formed at the periphery of the tapered bush 22. A tapered nut 23 having an internal threaded portion 231 is screwed to the external threaded portion 211 of the coupling body 21. The tapered nut 23 includes an outer cone 232 corresponding to the inner cone 221 of the tapered bush 22. In this way, the end portion of the flexible tube 10 is twisted to the stranded portion 212 of the main body 21 by the screwing force applied by the tapered bush 22 due to the tapering structure thereof. However, the twisting strength of the above-mentioned connector leaves much to be desired. The leakage takes place at the 394 kgf/cm² in the compression test while the detachment happens at the 50 kg in the tension test.

### SUMMARY OF THE INVENTION

An object of the invention is to eliminate the above-mentioned drawbacks and to provide a tapered type connector for a flexible tube that permits an excellent connection strength.

In order to achieve the above-mentioned objects, the invention includes:

a) a coupling body having an external threaded portion and a stranded portion at one side thereof, an annular cavity being formed in the external threaded portion such that the stranded portion is extended into the annular cavity, the defining wall of the annular cavity being tapered inward to form a first external fastening cone, the end portion of the flexible tube fitting over the stranded portion;

b) a clamp ring having at the internal end thereof a fist internal fastening cone facing to the first external fastening cone of the coupling body and at the external end thereof a second internal fastening cone, a clamp indentation being formed axially in the clamp ring, the clamp ring slipping over the periphery of the outer end of the flexible tube; and

c) a clamp nut having an internal threaded portion (corresponding to the external threaded portion of the coupling body) and a second external fastening cone (corresponding to the second internal fastening cone of the clamp ring).

Moreover, the flexible tube includes a core tube and a metal woven net enclosing the core tube. The core tube is made of Teflon. In addition, the clamp nut includes an opening at the external end thereof.

### BRIEF DESCRIPTION OF THE DRAWINGS

The accomplishment of this and other objects of the invention will become apparent from the following descriptions and its accompanying figures of which:

FIG. 1 is an exploded perspective view of a conventional connector;

FIG. 2 is a cutaway view of the conventional connector in a disassembly position;

FIG. 3 is a cutaway view of the conventional connector in an assembly position;

FIG. 4 is an exploded perspective view of the invention;

FIG. 5 is a cutaway view of the invention in a disassembly position;

FIG. 6 is a cutaway view of the invention in an assembly position; and

FIG. 7 is a cutaway view taken along the line 7-7 in FIG. 6.

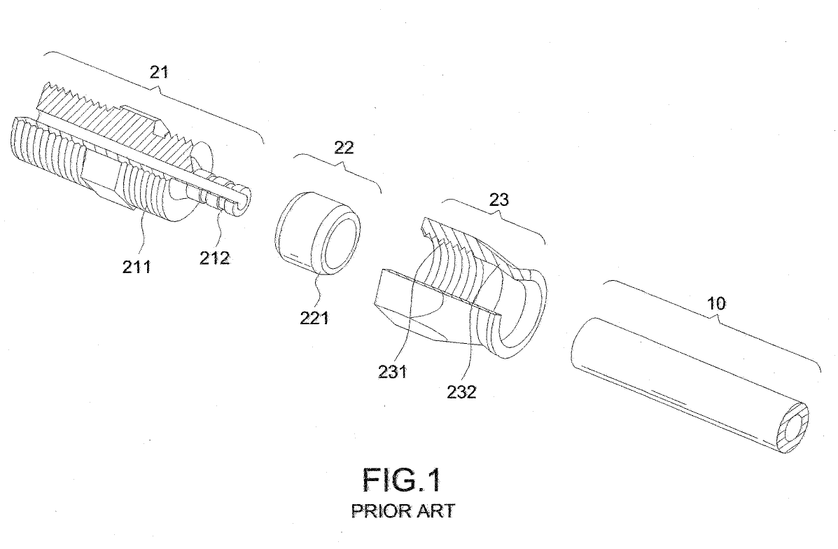

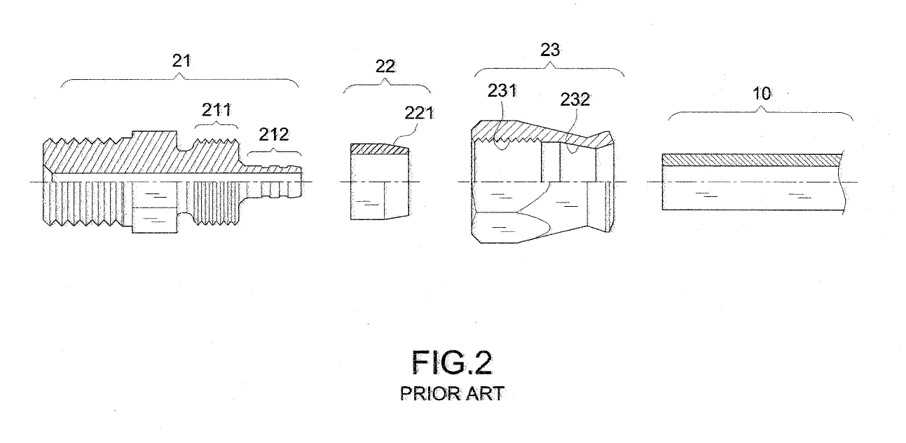

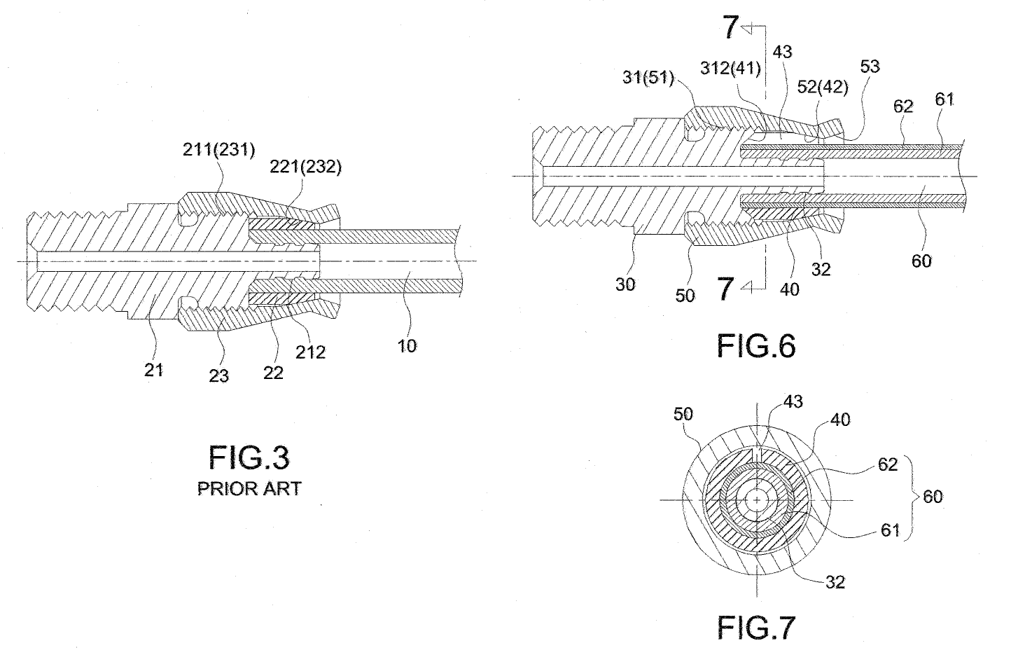

### DETAILED DESCRIPTION OF THE PREFERRED EMBODIMENT

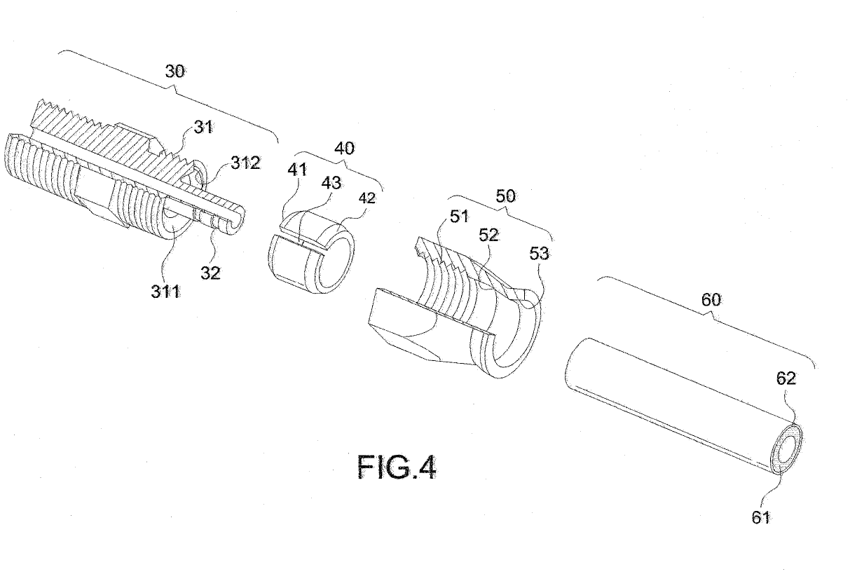

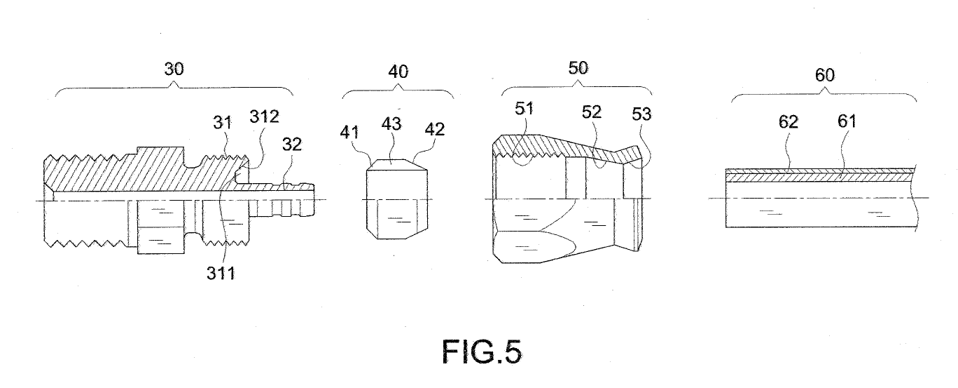

First of all, referring to FIGS. 4 through 7, the invention includes a coupling body 30, a clamp ring 40 and a clamp nut 50.

The coupling body 30 includes an external threaded portion 31 and a stranded portion 32 at one side thereof. An annular cavity 311 is formed in the external threaded portion 31 such that the stranded portion 32 is extended into the annular cavity 311. The defining wall of the annular cavity 311 is tapered inward to form a first external fastening cone 312. The end portion of the flexible tube 60 fits over the stranded portion 32.

The clamp ring 40 includes at the internal end thereof a fist internal fastening cone 41 facing to the first external fastening cone 312 of the coupling body 30 and at the external end thereof a second internal fastening cone 42. Moreover, a clamp indentation 43 is formed axially in the clamp ring 40. The clamp ring 40 slips over the periphery of the outer end of the flexible tube 60.

The clamp nut 50 includes an internal threaded portion 51 (corresponding to the external threaded portion 31 of the coupling body 30) and a second external fastening cone 52 (corresponding to the second internal fastening cone 42 of the clamp ring 40). Furthermore, the clamp nut 50 includes an opening 53 at the external end thereof.

The flexible tube 60 includes a core tube 61 made of Teflon and a metal woven net 62 enclosing the core tube 61. The flexible tube 60 serves as a brake oil tube such as hydraulic pressure pipe.

Based on the above-mentioned configuration, the first external fastening cone 312 of the coupling body 30 and the second external fastening cone 52 of the clamp nut 50 apply a compression force to the fist internal fastening cone 41 and the second internal fastening cone 42 of the clamp ring 40, respectively when the clamp nut 50 is gradually screwed onto the coupling body 30. The defining walls of the clamp indentation 43 of the clamp ring 40 contact to each other by the taper action via the screwing push force. In this way, the end portion of the flexible tube 60 is tightly secured by the clamp ring 40 to the stranded portion 32 of the coupling body 30. The leakage takes place when a pressure of 800 kgf/cm² is provided in the compression test, and the detachment occurs when 155 kg is provided in the tension test.

What is claimed is:

1. A tapered type connector for a flexible tube, comprising:
a) a coupling body having an external threaded portion and a stranded portion at one side thereof, an annular cavity being formed in the external threaded portion such that the stranded portion is extended into the annular cavity, the defining wall of the annular cavity being tapered inward to form a first external fastening cone, the end portion of the flexible tube fitting over the stranded portion;
b) a clamp ring having at the internal end thereof a fist internal fastening cone facing to the first external fastening cone of the coupling body and at the external end thereof a second internal fastening cone, a clamp indentation being formed axially in the clamp ring, the clamp ring slipping over the periphery of the outer end of the flexible tube; and
c) a clamp nut having an internal threaded portion (corresponding to the external threaded portion of the coupling body) and a second external fastening cone (corresponding to the second internal fastening cone of the clamp ring).

2. The tapered type connector for a flexible tube as recited in claim 1 wherein the flexible tube includes a core tube and a metal woven net enclosing the core tube.

3. The tapered type connector for a flexible tube as recited in claim 2 wherein the core tube is made of Teflon.

4. The tapered type connector for a flexible tube as recited in claim 1 wherein the clamp nut includes an opening at the external end thereof.
